(19) United States
(12) Patent Application Publication
(10) Pub. No.: US 2014/0334946 A1
(43) Pub. Date: Nov. 13, 2014

(54) LEAKAGE DETECTION SYSTEM AND METHOD FOR FUEL TANK SYSTEMS

(71) Applicant: VOLVO CAR CORPORATION, Goeteborg (SE)

(72) Inventors: Joakim Larvall, Goeteborg (SE); Magnus Forsberg, Goeteborg (SE)

(73) Assignee: VOLVO CAR CORPORATION, Goeteborg (SE)

(21) Appl. No.: 13/889,607

(22) Filed: May 8, 2013

(51) Int. Cl. F02M 21/02; G01M 3/04

(52) U.S. Cl. CPC F02M 21/0293; G01M 3/04
USPC 417/212; 73/40.5 R

(57) ABSTRACT

A method for detecting a leakage in a fuel tank system includes setting a first reference pressure value and generating an initial pressure in the fuel tank system, as well as determining a pressure difference between the pressure in the fuel tank system and the first reference pressure. The method also includes determining a linearity metric by comparing the determined pressure difference to at least one out of a linear and a non-linear data model, the linearity metric quantifying the non-linearity of said pressure difference as a function of time, and detecting a leakage in the fuel tank system based on the linearity metric, where a non-linear pressure difference function of time is indicative of a leakage in the fuel tank system.

### TECHNICAL FIELD

The present disclosure relates to leakage detection in fuel tank systems.

### BACKGROUND ART

Fuel vapors escaping from the fuel tank system of a vehicle are referred to as evaporative emissions. Such evaporative emissions are regulated in many countries, and limits are imposed on the amount of evaporative emission allowed from a vehicle. In order to secure that significant, i.e., non-allowable, evaporative emissions do not occur, evaporative emission leak detection systems have been developed and implemented in vehicles which are aimed at detecting the onset and presence of such evaporative emissions.

In this text the phrase fuel tank system will be used when referring to a fuel system of a vehicle, and in particular to the gas phase of the fuel system. Also, when referring to a pressure of the fuel tank system, absolute or relative, it is the pressure of the gas phase of the fuel tank system which is referred to.

Evaporative emission leak detection systems comprise pump and motor arrangements and natural vacuum arrangements.

Certain methods for detecting leaks are designed to generate an initial pressure in the fuel tank system. The pressure can be either an over-pressure or an under-pressure. Following pressure generation the means for generating pressure is switched off and the pressure in the tank system is measured in order to discern if the pressure drops or rises by more than a pre-determined reference value during a test interval. If the pressure drops or rises compared to the reference value integrity of the fuel tank system is denied, i.e., a leakage is detected, otherwise integrity is confirmed. A disadvantage with this system is that it is hard to decide whether the change in pressure is a result of a leak or condensation or evaporation of the fuel, or temperature changes in the fuel system. Hence, the test system is dependent on weather conditions, tank volume, type of fuel and other parameters that have an impact on condensation or evaporation of the fuel. As a consequence, the method becomes very time consuming if steady state conditions have to be awaited, and the risk of making an incorrect judgment becomes high, which may lead to high warranty costs for the manufacturer or to increased evaporative emissions in case a leaking fuel system is not found.

Certain pump and motor arrangements are designed to detect leakage by continuously generating a pressure in the fuel tank system. The pressure can be either an over-pressure or an under-pressure. During pressure generation the pressure in the tank system is measured and compared to a pre-determined reference value during a test interval. If the pressure drops or rises compared to the reference value integrity of the fuel tank system is denied, i.e., a leakage is detected, otherwise integrity is confirmed. A disadvantage with this system is that it is hard to decide whether the change in pressure is a result of a leak or condensation or evaporation of the fuel. Hence, the test system is dependent on weather conditions, tank volume, type of fuel and other parameters that have an impact on condensation or evaporation of the fuel. As a consequence, the method becomes very time consuming if steady state conditions have to be awaited.

Certain other pump and motor arrangements comprise a reference leakage arrangement, often in the form of a reference orifice of regulated dimension. A method for leakage detection is then to first pump with the reference orifice open towards atmosphere via an atmospheric port while measuring the pressure thus created. The atmospheric port is then closed and a port towards the tank system is instead opened. The pump now creates an over or under pressure in the tank system, and if this pressure differs from the pressure created while pumping through the reference orifice by more than a pre-determined amount the integrity of the tank system is denied. In this way a continuous pumping action is first used to determine a reference pressure by means of the reference orifice, followed by a continuous pumping action applied to the fuel tank system to see if the pressure thus created is in line with the reference pressure or if integrity of the fuel tank system should be denied. The problem with condensation and evaporation is present also for this type of arrangement.

A drawback of the pump and motor arrangements described is that the pump must be driven at a constant speed and with a pre-determined, continuous and constant flow, i.e., with no significant changes in pump flow, in order to give reliable detection results. Also, the pump flow must not be affected significantly by varying operating conditions, e.g., operating temperature. Further, it is critical that there are no significant manufacturing variations between different pump and motor individuals, and also between different versions and models of pumps and motors, as a common calibration value is preferred for all pump and motor arrangements. In summary, the requirement of continuous and constant flow in combination with hardware requirements on the pump and motor arrangement results in an increase in the production costs of the pump and motor components, and also in more complicated operation and calibration procedures.

Natural vacuum arrangements are similar in nature to the pump and motor arrangements, except that leakage detection is based on the monitoring of a natural vacuum which arises in the fuel tank system during certain operating conditions. Consequently the natural vacuum methods do not use pumps and motors. As an example, a natural vacuum method may close an electrical switchable valve towards atmosphere and register the pressure changes in the fuel tank system caused by changes in evaporation which in turn are caused by changes in, e.g., temperature. The registered pressure changes are then compared to pre-defined reference values and the integrity of the fuel tank system is determined based on the comparison results.

Natural vacuum arrangements, in order to be accurate, are known to require extensive calibration efforts, and are therefore cumbersome to implement and use. Thus, pump and motor systems are often preferred over natural vacuum arrangements. However, as mentioned above, pump and motor arrangements may be costly and are associated with certain drawbacks as outlined above.

Hence, there is a need for a low cost reliable method and system for detecting a leakage in a fuel tank system, suitably based on a pump and motor arrangement, but with reduced requirements on the pump and motor components, and with reduced procedural complexity.

U.S. Pat. No. 7,004,013 is directed to an evaporative emission leak detection system with brushless motor.

### SUMMARY

The present disclosure is directed to a method and a system for detecting a leakage in a fuel tank system which seeks to mitigate, alleviate, or eliminate one or more of the above-identified deficiencies and disadvantages in the art either singly or in any combination and to provide a low cost reliable means for detecting a leakage in a fuel tank system.

The disclosed method of the disclosure for detecting a leakage in a fuel tank system may comprise the steps of setting a first reference pressure value, and also the step of generating an initial pressure in the fuel tank system, as well as the step of calculating or measuring a pressure difference between the pressure in the fuel tank system and the first reference pressure. The method may further comprise the step of determining a linearity metric, by comparing the measured pressure difference to at least one out of a linear and a non-linear data model, the linearity metric quantifying the non-linearity of said pressure difference as a function of time. The method may also comprise the step of detecting a leakage in the fuel tank system based on the linearity metric, wherein a non-linear pressure difference function of time is indicative of a leakage in the fuel tank system.

Thus, a feature of the disclosure is that leakage detection is based on whether the measured pressure difference between the pressure in the fuel tank system and the first reference pressure is a non-linear function of time, as opposed to being a linear function of time. According to the disclosure, a non-linear behavior of the measured pressure difference as a function of time is indicative of a leakage in the fuel system. Thus, requirements on pump and motor components may be relaxed, since the principle behind leakage detection is not based on the actual initial pressure, which can vary from test to test, and also between vehicles. Nor is the leakage detection based on the characteristics on the generation of the initial pressure, which can be generated by a pressurizing flow with largely uneven and unpredictable flow level, as long as at least some initial pressure is generated.

As noted above, when referring herein to a pressure of the fuel tank system, absolute or relative, it is the pressure of the gas phase of the fuel tank system which is referred to.

It should be noted that the first reference pressure can be, e.g., zero bar. In this case, said pressure difference is really an absolute pressure in the fuel tank system, measured with respect to a unit pressure. Thus, in some embodiments of the disclosed method the measured pressure difference is an absolute pressure, while in other embodiments of the disclosed method the measured pressure difference is a relative pressure which describes the relation between the pressure in the tank system and the pressure of a reference system, e.g., the atmosphere or a different unit pressure, i.e., one bar.

Another feature of the disclosure is that an initial pressure, at a pre-determined pressure level, is generated in the system. The pre-determined pressure level may be a set value or may be the value reached after a certain time out period. Due to evaporation or condensation of the fuel and/or a large leak, it may be that the pre-determined pressure level cannot be reached within the time out period. The pump/compressor is shut off when the pre-determined pressure level or time out period is met. Hence, the means for generating said pressure is disabled or switched off. After that, the time behavior of pressure differences are monitored and used to detect leakage. This is different from the type of systems based on continuous pumping. A consequence of this difference is that the requirements on the pump and motor hardware, calibration, and operating procedure are significantly reduced, as any pump which can generate an over or under pressure in the fuel system can be used with the present disclosure with little or no need for calibration, since a well-defined continuous flow is not a requirement of the present method.

It should be noted that the exponential behavior is independent on the starting pressure difference, which means that the pre-determined pressure level may be the set value or may be the value reached after the time out period and the leak detection according to the present disclosure is still valid as long as the transients has no significant impact.

According to an embodiment, the method may further comprise the step of setting a second reference pressure value, as well as setting a reference time interval. The method may further comprise the step of determining an approached limit value of the pressure difference after the reference time interval has elapsed from the time of generating an initial pressure, and also the step of detecting a leakage in the fuel tank system if the linearity metric indicates the measured pressure difference to be a non-linear function of time, and the approached limit value is within a pre-determined distance from the second reference pressure.

Thus, in order for the method to declare a leakage in the fuel tank system, i.e., invalidating the integrity of the fuel tank system, two conditions should be fulfilled. Firstly, the pressure difference between that in the fuel tank system and the second reference pressure should exhibit a non-linear behavior when viewed as a function of time. Secondly, the measured pressure difference should appear to approach the second reference pressure, i.e., appear to converge towards the second reference pressure.

In embodiments of the disclosed method, the measured pressure difference is judged to approach or converge towards the second reference pressure if a mathematical model which has been fitted to a set or sub-set of measurements of pressure difference approaches the second reference pressure when extrapolated in time. In other words, if said fitted mathematical model converges towards the second reference pressure, and the measurements of pressure difference indicate a nonlinear trend as opposed to a linear trend, then integrity of the tank system is denied.

Said mathematical model will be further detailed below.

A benefit of this embodiment of the disclosed method is that pressure measurements do not need to be made during an extended period of time, but only until said mathematical model can be fitted to data with sufficient confidence, e.g., after approximately 5 minutes of measurements, as the fitted model parameters can be used to derive the point of convergence of the model extrapolated in time. This shortens leakage detection time, and is a benefit of the present disclosure.

An example of the second reference pressure which can be used in some embodiments of the disclosed method is an atmospheric pressure.

Said pre-determined distance from the second reference pressure will vary between embodiments and be dependent on the fuel tank system in general. The pre-determined distance may be determined by experimentations, and will suitably be measured in terms of pressure units, e.g., bars. It may also be adjustable during leakage detection system operation.

According to an embodiment, the step of generating further comprises generating an initial pressure in the fuel tank system which is higher than the second reference pressure. This means that an overpressure is generated in the fuel tank system. If there is a leakage in the fuel tank system, gas such as fuel vapors and air can be expected escape via the leakage, and, according to the disclosure, cause a fall in pressure which is non-linear.

According to an embodiment, the step of generating further comprises generating an initial pressure in the fuel tank system which is lower than the second reference pressure. In this case an under-pressure is generated in the fuel tank system. Differently from the case of generating an over-pressure, gas can now be expected to enter the fuel tank system via a leakage; however, according to the disclosure, the corresponding rise in pressure can be expected to be non-linear as opposed to being linear.

According to an embodiment, the step of measuring further comprises repeatedly measuring a pressure in the fuel system, and comparing said measured pressure to the first reference pressure in order to determine the pressure difference, as well as repeatedly storing the determined pressure difference together with a corresponding measurement time.

Repeatedly measuring is here to be interpreted as either discretely measuring on a fixed number of occasions or continuously measuring and discretely sampling the measurement and storing the sampled measured pressure value. In this way a time series of pressure differences is generated which can be analyzed and further processed by the leakage detection system.

According to an embodiment, the step of determining a linearity metric may comprise the step of fitting a non-linear data model to the measured pressure difference data and also evaluating the resemblance between the fitted non-linear data model and the monitored pressure difference data, thus determining the non-linearity of the monitored pressure data as a function of time.

Here, the term linearity metric should be interpreted in a broad sense, meaning that many different types of metrics can be envisioned. One way, as indicated above, is to fit a data model to the measured pressure difference data and simply determine a difference between the measured data and the data generated from the fitted data model. The specific method used for fitting the model can also be done in many different ways.

In case there is a large discrepancy between model and measurements, larger than some pre-determined threshold, the measured data cannot be said to resemble the model. Consequently, in case the model is a non-linear model such as an exponential model, the linearity metric does not indicate a non-linear pressure difference behavior in case of a large discrepancy.

According to an embodiment, the step of determining a linearity metric may further comprise the step of fitting a linear data model to the monitored pressure difference data, as well as the step of selecting the linear model or the non-linear model which shows the closest resemblance to the monitored pressure difference data, thus quantifying the non-linearity of the monitored pressure data as a function of time. In this embodiment the resemblance between the measured data and the linear and non-linear models are compared, and a binary decision is made in favor of the model with closest resemblance. This binary decision may simplify the problem of determining non-linearity, as no absolute non-linearity criteria are needed. Rather, the decision on non-linearity can be made on a relative basis.

According to an embodiment, the linear or non-linear data model is fitted to a subset of the monitored pressure difference data, selected by means of a time window of pre-determined start and end instants. Thus, un-wanted phenomena such as transient behavior in the pressure difference can be avoided in the measurement data. The reason being that due to transient effects, a pressure difference curve which is essentially linear can exhibit severe non-linear behavior in the first few seconds following generation of initial pressure.

Normally, transient effects in the pressure difference occur in the tank system following initial pressure generation. The transients are the result of for example evaporation and condensation and are dependent in time on how fast the pressure is generated. The transient effects occur during a longer time period if the pressure is generated fast. In systems suitable for a tank in a vehicle transient effects normally does not last longer than 30 seconds. Also, a monitoring time of about four to five minutes is usually sufficient in order to reach required confidence in the fitting of data models. Thus, according to an embodiment, said time window starts after the transients have no longer an impact, e.g. approximately 30 seconds after initial pressure generation and ends when enough data has been collected to ensure the fitting of data into the model, e.g. approximately 5 minutes after initial pressure generation. Thus initial transient effects are avoided and the measurement time is limited, following which a leakage detection procedure is instigated.

According to an embodiment, the non-linear model is an exponential model of pressure P(t) over time t, which exponential model comprises parameters A, B, C and k, according to P(t)=Ae^{-kt}+Ct+B.

According to an embodiment, the non-linear model is a polynomial model of pressure P(t) over time t, with parameters describing the coefficients of terms in the polynomial. Said polynomial is suitably an affine polynomial.

According to an embodiment, the non-linear model may be the result of interpolation in a table of pre-set values determined by experimental data for the system.

According to an embodiment, the step of fitting a data model may comprise a least-squares method of fitting, and the step of selecting comprises selecting based on the residual least-squares error of the linear model and the non-linear data model. Of course, the least squares method which minimizes the sum of squares of sample error is just one option of fitting. Other performance criteria can be envisioned to be minimized, including Euclidean norm, Frobenius norm, and various types of weighted distance criteria, e.g., weighted least squares.

When fitting data models to measured data, the amount and characteristics of measurement noise may be considered. Thus, it may be beneficial to first filter measurement data prior to fitting a data model in order to suppress measurement noise.

According to an embodiment, the first reference pressure and the second reference pressure may both correspond to atmospheric pressure.

According to an embodiment, the method may further comprise verifying the integrity of a fuel tank system if either the determined approached limit value is not within the pre-determined distance from the second reference pressure or if the determined linearity metric indicates that the monitored pressure difference resembles a linear function of time as opposed to a non-linear function of time.

A leakage detection system for detecting a leakage in a fuel tank system is also disclosed. The leakage detection system may comprise means to generate a pressure in the fuel tank system, such as a pump or compressor, and means to measure a pressure in the fuel tank system, such as a sensor or sensor unit. The leakage detection system may also comprise a control unit arranged to calculate and record a pressure difference between the pressure in the fuel tank system and a first reference pressure over time. The control unit is adapted to determine a linearity metric and an approached limit value with respect to a second pressure.

As discussed above, the linearity metric indicates whether the measured pressure difference is essentially a linear function of time as opposed to being a non-linear function of time.

The approached limit value represents a steady state pressure of the fuel system after a reference time interval has elapsed since the generation of pressure in the fuel tank system, signified by no significant pressure change over time. As mentioned above, the approached limit value is in some embodiments of the disclosed method derived from a mathematical model which has been fitted to measurements of pressure in the tank system, or a sub-set of measurement of pressure in the tank system. In some embodiments of the disclosed method, the approached limit value is calculated after pressure measurements have been concluded.

The control unit is adapted to detect a fuel leakage if the linearity metric indicates the measured pressure difference to be a non-linear function of time, and the approached limit value is within a pre-determined distance from a second reference pressure.

The approached limit value may in embodiments be interpreted as a state of lowest potential energy. For instance, if the generated pressure is an over-pressure and there is a leakage somewhere in the fuel tank system, the pressure in the system can be expected to converge to the pressure of the gas surrounding the fuel tank system, which can be an atmospheric pressure. Also, as discussed above, the change in pressure difference in case of leakage can be expected to be a nonlinear function of time, as opposed to being a linear function of time.

According to an embodiment, the control unit is further adapted to adjust the parameters of a non-linear data model to fit the measured pressure difference data, and also to determine the linearity metric by means of calculating the difference between the measured pressure data and the adjusted non-linear data model.

According to an embodiment, the control unit is further arranged to adjust the parameters of the non-linear data model to minimize a least-squares objective function, and to determine the linearity metric by means of the residual least-squares error of the adjusted non-linear model with respect to the measured pressure difference. Alternatively, the control unit may in embodiments use a weighted form a least-squares data fitting, e.g., weighted least squares.

According to an embodiment, the control unit is further arranged to detect a fuel leakage if the determined approached limit value of the monitored pressure difference is within a first pre-determined distance from the second reference pressure and the determined linearity metric indicates a non-linear change in the monitored pressure difference over time as opposed to a linear change in the monitored pressure difference over time.

According to an embodiment, the control unit is further arranged to verify the integrity of the fuel system if either the determined approached limit value of the measured pressure difference is not within a first pre-determined distance from the second reference pressure or if the determined linearity metric indicates a linear change in the measured pressure difference over time as opposed to a non-linear change in the measured pressure difference over time.

According to an embodiment, the means to generate a pressure comprises a pump driven by a motor. Other means of pressure generation can also be envisioned, for instance, using an ejector in order to generate an under-pressure in the fuel tank system, or using so-called natural vacuum methods for generating under-pressure in the fuel tank system.

A fuel system comprising leakage detection suitably used in a vehicle is further disclosed herein. The fuel system is connected to atmosphere via a first control valve. The fuel system may comprise a fuel tank connected to one single sensor unit or to an arrangement comprising a plurality of sensor units. The sensor unit or sensor unit arrangement is arranged to measure a pressure in the fuel system and to communicate said measured pressure to a control unit. The fuel system may further comprise a pump driven by a motor. The pump is connected to, i.e., in fluid communication with, the fuel tank via a first port of the pump, the pump further comprising a second port connected to atmosphere via a second control valve. The pump is arranged to generate a pressure difference in the fuel system with respect to an atmospheric pressure.

The control unit is adapted to determine a linearity metric and an approached limit value of the pressure in the fuel system with respect to atmospheric pressure. The linearity metric indicates, as discussed above, whether the monitored pressure difference is essentially a linear function of time as opposed to being a non-linear function of time. The approached limit value indicates a steady state pressure of the fuel system signified by no significant pressure change over time. The control unit is adapted to detect a fuel leakage based on said determined linearity metric and approached limit value. The fuel system may further comprise a canister disposed between the first port of the pump and the fuel tank. Thus, in certain embodiments of the disclosure, an input to the tank from the pump, or an output from the tank to the pump, passes via said canister. The canister is arranged to capture and store an evaporative emission of fuel from the fuel tank. The canister is further connected to a purge valve facilitating the purging of said captured evaporative emission from the canister.

The method and system according to the disclosure may be implemented by measuring from a starting point where transients have no significant impact to an end point where it is possible to see or analyze the asymptotic behavior towards the second reference value. The method and system according to the disclosure may alternatively be implemented by measuring from a starting point where transients have no significant impact and then calculating an end point where it is possible to analyze the asymptotic behavior towards the second reference value.

### BRIEF DESCRIPTION OF THE DRAWINGS

The disclosure will be described in more detail in the following, with reference to the appended drawings, in which

FIG. 1 shows a flowchart of a method of the disclosure, and

FIG. 2a shows a first graph visualizing a plurality of pressure difference curves, and

FIG. 2b shows a second graph visualizing a plurality of pressure difference curves, and

FIG. 3 shows a first fuel tank system of the disclosure, and

FIG. 4 shows a second fuel tank system of the disclosure.

### DETAILED DESCRIPTION

As required, detailed embodiments are disclosed herein. However, it is to be understood that the disclosed embodiments are merely exemplary and that various and alternative forms may be employed. The embodiments are included in order to explain principles of the disclosure and not to limit the scope thereof, which is defined by the appended claims. Details from two or more of the embodiments may be combined with each other. The figures are not necessarily to scale. Like reference characters refer to like elements throughout the description. Some features may be exaggerated or minimized to show details of particular components. Therefore, specific structural and functional details disclosed herein are not to be interpreted as limiting, but merely as a representative basis for teaching one skilled in the art. The terminology used herein is for the purpose of describing particular embodiments only, and is not intended to limit the disclosure.

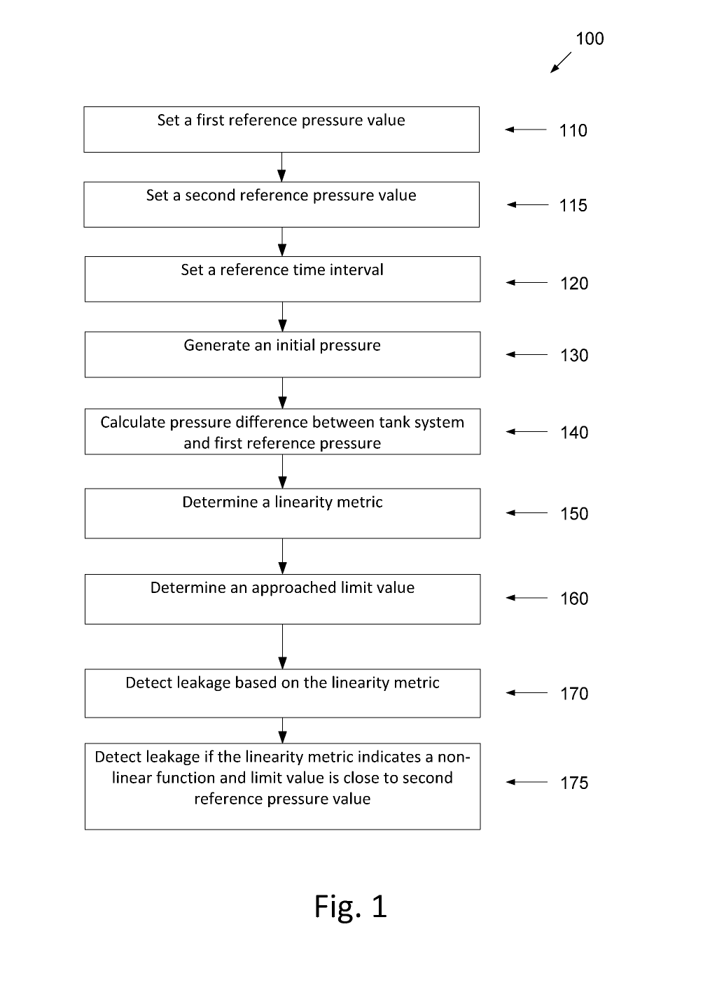

FIG. 1 shows a flowchart of a method 100 of the disclosure. The method may comprise, as has been discussed above, the step 110 of setting a first reference pressure value, and the step 115 of setting a second reference pressure value, as well as the step 120 of setting a reference time interval. Following the setting of reference values, an initial pressure is generated in the fuel tank system in step 130 of the method 100. The method 100 may further comprise the step of measuring the pressure difference between the fuel tank system and the first reference pressure. The method 100 in embodiments may also comprise the step 150 of determining a linearity metric, and also the step 160 of determining an approached limit value. The method 100 may further comprise the step 170 of detecting a leakage in the fuel tank system based on said linearity metric. According to an embodiment, the method 100 detects a leakage if the linearity metric indicates a non-linear pressure difference function of time, and the approached limit value of the measured pressure difference is close to the second reference pressure value.

As noted above, when referring herein to a pressure of the fuel tank system, absolute or relative, it is the pressure of the gas phase of the fuel tank system which is referred to.

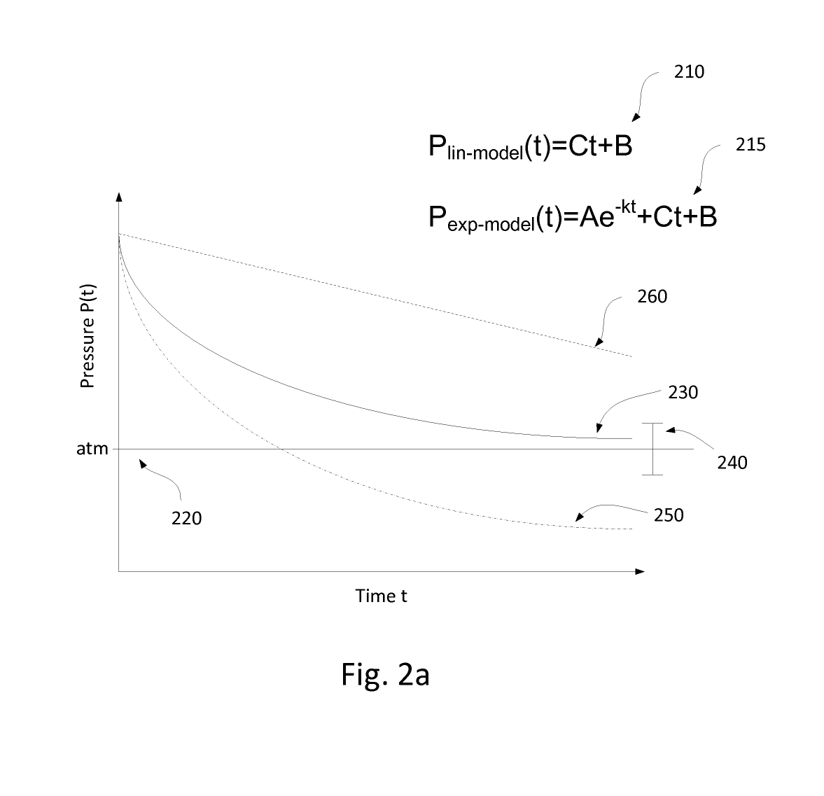

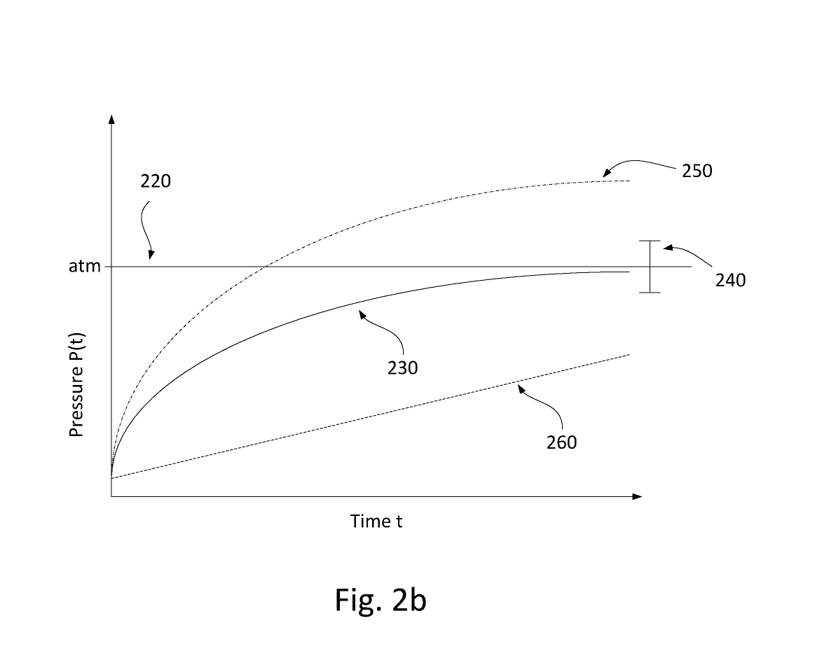

FIG. 2a shows a graph visualizing a plurality of pressure difference curves 230, 250, 251, 260. Time is shown on the x-axis, and pressure is shown on the y-axis. The units of time and pressure may be seconds and bars, but other units are also possible. Two exemplary data models are shown, a linear data model 210, and a non-linear data model 215, both of which are functions of time t. The linear data model 210 has two parameters which are adjusted when the model is fitted to some measurement data. The two parameters of the linear model is B describing the model bias, and C describing the rate of change with time. The non-linear data model 215 is an exponential data model with the four parameters A, B, C, and k. It is these four parameters which are adjusted, i.e., determined, when the model is fitted to measurement data. FIG. 2a also shows four functions of time; A reference pressure 220 is shown as a straight line, here indicated to be an atmospheric pressure atm. A first non-linear pressure difference curve 230 is shown which approaches the reference pressure curve 220, meaning that it appears to converge to within a distance 240 of the reference curve 220 after some time has passed. A second non-linear curve 250 is shown which does not appear to converge towards the reference curve 220. Also, a linear curve 260 is shown.

Assuming that the y-axis in FIG. 2a represents increasing pressure in the direction indicated by the arrow, the pressure difference curves 230, 250, 260 all declines as time progresses. The initial pressure generated in this case is an over-pressure with respect to the reference pressure curve.

FIG. 2b, as opposed to FIG. 2a, shows a plurality of pressure difference curves which rise as time progresses, assuming that the y-axis in FIG. 2b represents increasing pressure in the direction indicated by the arrow. The initial pressure generated in this case is an under-pressure with respect to the reference pressure curve.

According to an embodiment, the pressure difference curves shown in FIG. 2a and FIG. 2b represent extrapolated mathematical models which have been fitted to measurements of pressure differences in a tank system. Thus the point of convergence of the curves can be discerned prior to the actual converge instant in time.

The pressure difference curves 250 and 251 which both exhibit a clear non-linear trend but which do not converge towards the reference pressure 220, and are thus not indicative of a leakage in the fuel tank system, can be caused by evaporation phenomena in the fuel tank system, and condensation phenomena in the fuel tank system. It can be expected that evaporation phenomena in the fuel tank system leads to a steady state pressure which is higher than the reference pressure, while condensation phenomena in the fuel tank system leads to a pressure difference below the reference pressure.

According to the disclosure curve 260 does not indicate a leakage since it appears to be a linear function of time. The curve 250 is non-linear; hence it is indicative of a leakage. However, it does not appear to converge towards the reference pressure level as defined by curve 220, hence in embodiments no leakage would be declared. The curve 230 however, appears to be non-linear at the same time as it converges to within the pre-determined distance 240 of the reference pressure curve 220. Hence, leakage would be detected by the system.

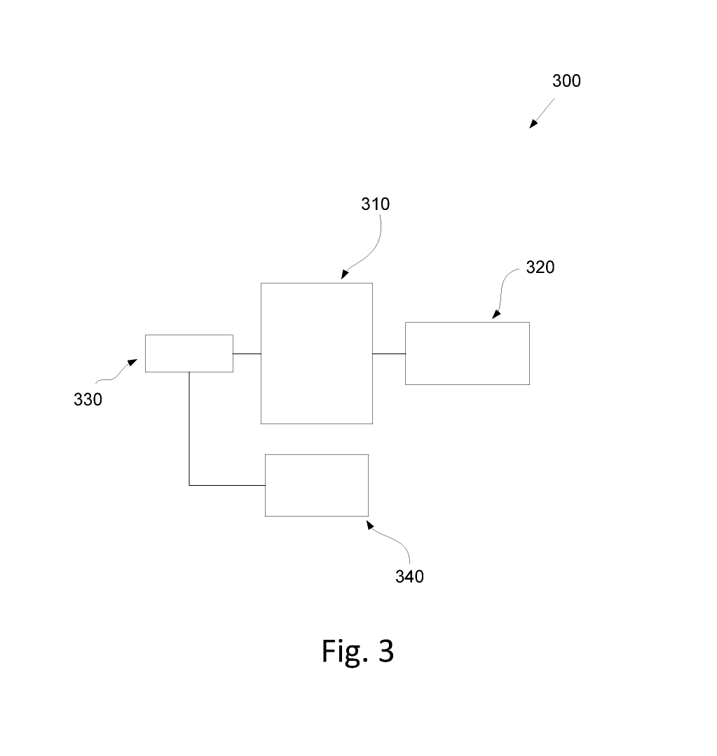

FIG. 3 shows a first fuel system 300 of the disclosure arranged to detect a leakage in a fuel tank system. The system 300 may comprise a fuel tank system 310, which fuel tank system 310 in embodiments comprises at least a fuel tank. A sensor 330 is disposed in connection to the fuel tank system 310. The sensor is arranged to measure a pressure of the fuel tank system 310, it is therefore in fluid communication with the fuel tank system 310. A control unit 340 is connected to the sensor unit 330. The system 300 may further comprise means for pressure generation 320, such as a pump or compressor, which means 320 is in fluid communication with the fuel tank system 310.

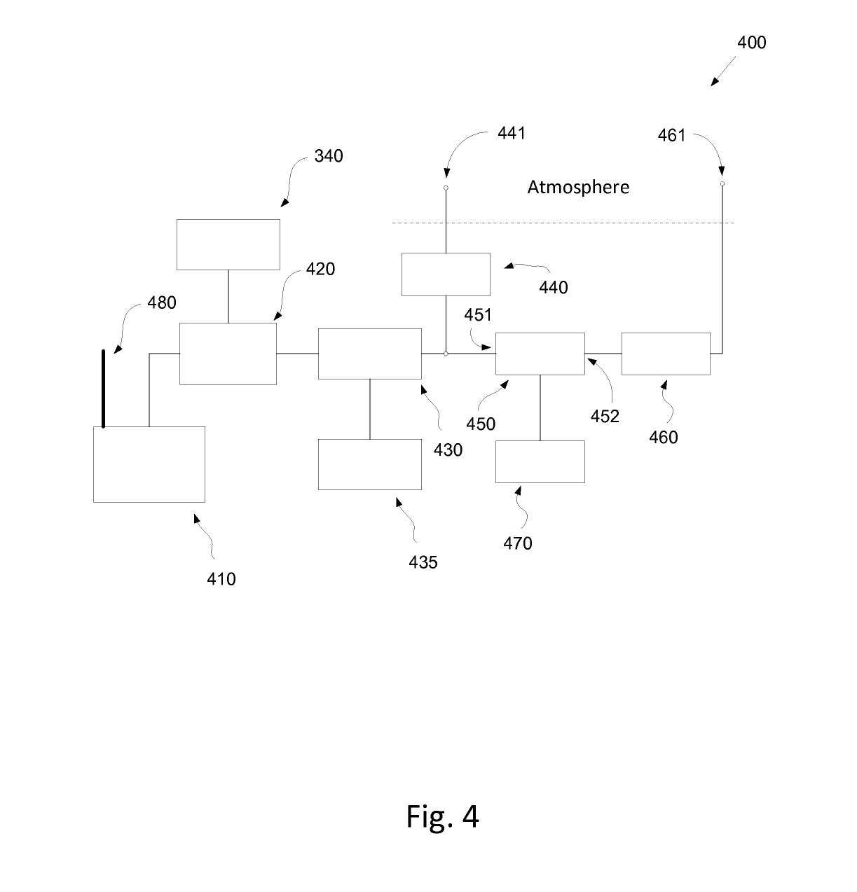

FIG. 4 shows a second fuel system 400 of the disclosure arranged to detect a leakage in a fuel tank system. The system 400 may comprise a fuel tank 410 in fluid communication with a pressure sensor unit 420. The pressure sensor unit 420 is connected to a control unit 340 arranged to process pressure measurement data from the pressure sensor unit 420. The fuel tank 410 is also in fluid communication with a canister 430. The fluid communication between the fuel tank 410 and the canister 430 is in embodiments via the pressure sensor 420, but other pressure sensor installations are possible. The canister 430 is further in fluid communication with a purge valve arrangement 435 for purging of the canister 430 contents. The canister 430 and purge valve 435 are in embodiments of the disclosure part of a so-called evaporative emission control system.

The fuel tank system may further comprise a conduit connected to atmosphere 441 via a first control valve 440. This conduit is arranged to facilitate fuel tank system intake or outlet of gases to and from atmosphere.

The fuel tank 410 is further in fluid communication with a pump 452 arranged to be driven by a motor 470. The fluid communication between fuel tank 410 pump 450 is via either of the pressure sensor 420 and the canister 430 or both of the pressure sensor 420 and the canister 430. The pump may comprise a first port 451 towards the fuel tank system, and a second port 452 towards atmosphere 461. A second control valve 460 is disposed between the pump 450 and atmosphere 461.

Note that just a single sensor unit is shown in FIG. 3 and FIG. 4, however, a plurality of sensor units is possible. Also, pluralities of co-operating control units are possible in embodiments.

It should also be noted that the disposition and arrangement of control valves may vary between embodiments. Thus, the control valve 460 may in embodiments be placed after the pump 450, i.e., between the pump 450 and the fuel tank 410. Further, the control valve 460 may in embodiments comprise a non-return valve.

The location of the pressure sensor unit 420, which pressure sensor 420 is shown in FIG. 4 to be located between the fuel tank 410 and the canister 430, may also vary between embodiments. The pressure sensor unit 420 may in embodiments be connected anywhere in the fuel system gas phase, as long as the pressure of the fuel tank system gas phase can be determined by means of the pressure sensor unit 420. For example, the pressure sensor unit 420 may in embodiments be located between the canister 430 and the pump 450.

FIG. 4 further shows a fuel tank filler arrangement 480. Clearly, when no fuel cap or other sealing means are present and adapted to seal the fuel tank system, a leakage will be detected by the disclosed method. Consequently, the disclosed method can also be used to detect a missing fuel cap or similar sealing means. Following detection of a missing fuel tank sealing means, e.g., a fuel cap, an alert indicating the fact can be generated.

The fuel tank filler arrangement 480 may in embodiments comprise a sensor arrangement for detecting when the fuel tank filler cap is missing. When such a sensor indicates a missing fuel tank filler cap, leakage detections are suitably discarded by the disclosed method since the leakage detection system cannot be relied upon when the fuel tank system is not properly sealed by the sealing means.

Embodiments of the disclosed method may further comprise the step of classifying a detected leak as being a small leak or a large leak.

Such a classification/approximation can be achieved by using the value A and k in the mathematical non-linear exponential model P(t)=Ae^{-kt}+Ct+B. In general a large value of A and k is an indication of a large leak size, and small values of A and k may indicate a small leak. What values of A and k corresponds to what leak sizes may be determined by controlled calibration measurements. The values of C and B corresponds to other physical properties than leak size, such as evaporation or condensation of fuel and temperature changes in the fuel tank during the measurement phase. These effects do in general not have an exponential influence on the pressure as a function of time. In this way the test becomes independent of evaporation of fuel and temperature changes, which is a common problem in other methods for leakage detection.

The classification of the leak size may also have a fuel tank gas phase volume dependence. The volume may be measured using the fuel level sensor, or by other methods.

It should be noted that the method of detecting a leak by comparison may be done by using a table of preset values and interpolation of values in the table in order to find the linearity or non-linearity behavior of the measurements.

The classification of small leak or large leak may be done by starting with a polynomial or table and finding a corresponding non-linear exponential model P(t)=Ae^{-kt}+Ct+B, or may be done by using a different mathematical representation that gives the same information as the A and k parameters in the exponential model.

It should be noted that the k-factor does not change along the curve P(t) described by P(t)=Ae^{-kt}+Ct+B and therefore it does not matter where on the curve, i.e. during which time interval the k-factor is measured/calculated as long as the transients has no significant impact.

It should also be noted that the exponential behavior and the k-factor are independent on the starting pressure difference, which means that the pre-determined pressure level may be the set value or may the value reached after the time out period and the leak detection according to the present disclosure is still valid.

The foregoing has described principles, embodiments and modes of operation of the present disclosure. However, the disclosure should be regarded as illustrative rather than restrictive, and not as being limited to the particular embodiments discussed above. The different features of the various embodiments of the disclosure can be combined in other combinations than those explicitly described. It should therefore be appreciated that variations may be made in those embodiments by those skilled in the art without departing from the scope of the present disclosure as defined by the following claims.

What is claimed is:

1. A method for detecting a leakage in a fuel tank system, the method comprising:
generating an initial pressure in the fuel tank system;
determining a pressure difference between the initial pressure in the fuel tank system and a first reference pressure;
determining a linearity metric, by comparing the determined pressure difference to at least one out of a linear and a non-linear data model, the linearity metric quantifying the non-linearity of the pressure difference as a function of time; and
detecting a leakage in the fuel tank system based on the linearity metric, wherein a non-linear pressure difference as a function of time is indicative of a leakage in the fuel tank system.

2. The method of claim 1, further comprising:
setting a first reference pressure value;
setting a second reference pressure value;
setting a reference time interval;
determining an approached limit value of the pressure difference after the reference time interval has elapsed from the time of generating an initial pressure; and
detecting a leakage in the fuel tank system if the linearity metric indicates the measured pressure difference to be a non-linear function of time, and the approached limit value is calculated to be within a pre-determined distance from the second reference pressure.

3. The method of claim 2, wherein generating further comprises generating an initial pressure in the fuel tank system which is higher than the second reference pressure.

4. The method of claim 2, wherein generating further comprises generating an initial pressure in the fuel tank system which is lower than the second reference pressure.

5. The method of claim 1, wherein determining a pressure difference further comprises repeatedly measuring a pressure in the fuel system, and comparing said measured pressure to the first reference pressure in order to determine the pressure difference, as well as repeatedly storing the determined pressure difference together with a corresponding measurement time.

6. The method of claim 1, wherein determining a linearity metric comprises fitting a non-linear data model to the measured pressure difference data and also evaluating the resemblance between the fitted non-linear data model and the monitored pressure difference data, thus determining the non-linearity of the monitored pressure data as a function of time.

7. The method of claim 6, wherein determining a linearity metric further comprises fitting a linear data model to the monitored pressure difference data, as well as the step of selecting the linear model or the non-linear model which shows the closest resemblance to the monitored pressure difference data, thus quantifying the non-linearity of the monitored pressure data as a function of time.

8. The method of claim 7, wherein the linear or non-linear data model is fitted to a subset of the monitored pressure difference data, selected by use of a time window of pre-determined start and end instants.

9. The method of claim 7, wherein the non-linear model is either of an exponential model of pressure P(t) over time t, which exponential model comprises parameters A, B, C and k, according to P(t)=Ae^{-kt}+Ct+B, or an affine polynomial model of a pre-determined degree, which polynomial model comprises parameters describing the coefficients of the polynomial function.

10. The method of claim 6, wherein fitting a data model comprises a least-squares method of fitting, and wherein selecting comprises selecting based on the residual least-squares error of the linear model and the non-linear data model.

11. The method of claim 2, wherein the first reference pressure and the second reference pressure both correspond to atmospheric pressure.

12. The method of claim 2, further comprising verifying the integrity of a fuel tank system if either the determined approached limit value is not within the pre-determined distance from the second reference pressure or if the determined linearity metric indicates that the monitored pressure difference resembles a linear function of time as opposed to a non-linear function of time.

13. A leakage detection system for detecting a leakage in a fuel tank system, the leakage detection system comprising:
a control unit configured to determine and record a pressure difference between a pressure generated in the fuel tank system and a first reference pressure over time;
wherein the control unit is adapted to determine a linearity metric and an approached limit value with respect to a second pressure, the linearity metric indicating whether the determined pressure difference is generally a linear function of time as opposed to a non-linear function of time, the approached limit value indicating a steady state pressure of the fuel system after a reference time interval has elapsed since a generation of pressure in the fuel tank system, signified by no significant pressure change over time, and wherein the control unit is adapted to detect a fuel leakage if the linearity metric indicates the determined pressure difference to be a non-linear function of time, and the approached limit value is within a pre-determined distance from a second reference pressure.

14. The leakage detection system of claim 13, wherein the control unit is further adapted to adjust the parameters of a non-linear data model to fit the determined pressure difference data, and also to determine the linearity metric by calculating the difference between the determined pressure data and the adjusted non-linear data model, and to also determine the approached limit value by extrapolation of the adjusted non-linear data model.

15. The leakage detection system of claim 14, wherein the non-linear data model is either of an exponential model of pressure P(t) over time t, which exponential model P(t) comprises parameters A, B, C and k, according to P(t)=Ae^{-kt}+Ct+B, or an affine polynomial model of a pre-determined degree, which polynomial model comprises parameters describing the coefficients of the polynomial function.

16. The leakage detection system of claim 14, wherein the control unit is further adapted to adjust the parameters of the non-linear data model to minimize a least-squares objective function, and to determine the linearity metric by a residual least-squares error of the adjusted non-linear model with respect to the determined pressure difference.

17. The leakage detection system of claim 13, wherein the control unit is further adapted to detect a fuel leakage if the determined approached limit value of the determined pressure difference is within a first pre-determined distance from the second reference pressure and the determined linearity metric indicates a non-linear change in the determined pressure difference over time as opposed to a linear change in the determined pressure difference over time.

18. The leakage detection system of claim 13, wherein the control unit is further adapted to verify the integrity of the fuel system if either the determined approached limit value of the determined pressure difference is not within a first pre-determined distance from the second reference pressure or if the determined linearity metric indicates a linear change in the determined pressure difference over time as opposed to a non-linear change in the determined pressure difference over time.

19. The leakage detection system of claim 13 further comprising:
a sensor configured to measure a pressure in the fuel tank system; and
a device configured to generate a pressure in the fuel tank system.

20. A fuel system comprising:
a control unit;
a fuel tank;
a sensor unit adapted to measure a pressure in the fuel system and to communicate said measured pressure to the control unit;
a pump configured to connect to the fuel tank via a first port of the pump, the pump having a second port connected to atmosphere via a control valve, the pump adapted to generate a pressure difference in the fuel system with respect to an atmospheric pressure;
wherein the control unit is adapted to determine a linearity metric and an approached limit value of the pressure in the fuel system with respect to atmospheric pressure, the linearity metric indicating whether a determined pressure difference is generally a linear function of time as opposed to a non-linear function of time, the approached limit value indicating a steady state pressure of the fuel system signified by no significant pressure change over time, the control unit further adapted to detect a fuel leakage based on said determined linearity metric and approached limit value; and
a canister configured for arrangement between the first port of the pump and the fuel tank, so that an input to the tank from the pump, or an output from the tank to the pump, passes via said canister, the canister adapted to capture and store an evaporative emission of fuel from the fuel tank, the canister further adapted to connect to a purge valve facilitating the purging of said captured evaporative emission from the canister.
